(19) United States
(12) Patent Application Publication
(10) Pub. No.: US 2025/0052337 A1
(43) Pub. Date: Feb. 13, 2025

(54) METHOD AND SYSTEM FOR OPERATING ACTUATORS

(71) Applicant: ROTORK CONTROLS LIMITED, Bath (GB)

(72) Inventors: Naomi Meakin, Bath (GB); Kevin Vans-Colina, Bath (GB); Daniel Mallin, Bath (GB); Philip Hall, Bath (GB); Simon Nottingham, Bath (GB)

(21) Appl. No.: 18/720,634

(22) PCT Filed: Dec. 8, 2022
(86) PCT No.: PCT/GB2022/053142

§ 371 Date: Jun. 15, 2024

(30) Foreign Application Priority Data
Dec. 16, 2021 (GB) 2118289.4

(51) Int. Cl. F16K 37/00; F16K 31/04

(52) U.S. Cl. CPC F16K 37/0083; F16K 31/046

(57) ABSTRACT

An actuator for a flow control valve comprises an electric motor (112) for driving an output shaft connected to the valve; an electric power supply (128) having a characteristic feature for defining an intended direction of drive of the electric motor; a sensor (132) for detecting the characteristic feature; a connector (134) for connecting the electric current supply to the electric motor; and a control system (130) arranged to connect the electric power supply to the electric motor. Operation of the actuator comprises providing electric current; detecting the characteristic feature; determining the intended direction of drive of the electric motor from an output of the sensor indicative of the characteristic feature of the electric current; determining that there are no predetermined conditions inhibiting operation of the electric motor in the intended direction of drive of the electric motor; and operating the connector to connect the electric power supply to the electric motor.

### FIELD

This invention relates to methods and systems for operating actuators such as those used to operate valves, dampers, or the like.

### BACKGROUND

Actuator operated valves are found in many industries. A complex installation, such as found in oil and gas facilities, may include many such actuators. These are often controlled remotely from a limited number of locations in the installation to open or close on command. In some known systems, control of actuators has been achieved by modifying the three-phase electric power supply used to power the motors operating the actuators. For example, the A Range actuators of Rotork plc (https://www.rotork.com/uploads/documents-versions/2875/1/pub003-001-00_0401.pdf) are operated by changing the phase sequence (also known as “phase rotation”) of the three-phase supply. The operator will direct a three-phase supply to a given actuator with a given phase sequence. The actuator will have been manually configured when installed or set up so that this will result in the motor driving in a given direction. The operator can reverse this direction by reversing two of the three phases which immediately leads to the motor operating in the reverse direction.

A more advanced type of actuator can have an electronic control system included in the actuator. However, these systems typically require the presence of a separate control circuit in addition to the three-phase power supply. An example of this is the AWT SynchroPAK range of Rotork plc (https://www.rotork.com/uploads/documents-versions/21705/1/pub005-002-00_0715.pdf). This product provides a control system between the three-phase supply and the motor. The control system has a separate control circuit input that is used to provide inputs to the control system to control operation of the actuator. The control system is configured so that the motor drive direction is determined for opening or closing the valve, and the control system ensures that the phase sequence applied to the motor is correct for that direction, irrespective of the phase sequence delivered to the actuator. Therefore, even if the phase sequence supplied to the actuator changes during an open or close operation, or remains constant over all operations, the control system will ensure that the motor will operate in the desired direction. Actuators such as these are not compatible with control via the three-phase supply.

This invention aims to provide an actuator with an electronic control system that can be operated in a manner that is reverse compatible with three-phase control systems and, more broadly, allows the power supply for the motor to be used to control the direction of the motor.

### SUMMARY

One aspect of this invention comprises a method for operating an actuator for a flow control valve or the like, wherein the actuator comprises:
an electric motor for driving an output shaft connected to a flow control valve;
an electric power supply for powering the electric motor, wherein the electric power has a characteristic feature defining an intended direction of drive of the electric motor;
a sensor for detecting the characteristic feature;
an operable connector for connecting the electric power supply to the electric motor; and
a control system arranged to operate the connector to connect the electric power supply to the electric motor;
the method comprising:
providing electric power on the supply;
using the sensor to detect the characteristic feature of the electric power;
using the control system to determine the intended direction of drive of the electric motor from an output of the sensor indicative of the characteristic feature of the electric power;
using the control system to determine that the actuator complies with a set of predetermined operating conditions for operation of the electric motor in the intended direction, and inhibiting operation of the electric motor if the actuator does not comply with any of the set of predetermined operating conditions; and
using the control system to operate the connector to connect the electric power supply to the motor.

Another aspect of the invention comprises an actuator for a flow control valve or the like, comprising:
an electric motor for driving an output shaft connected to a flow control valve;
an electric power supply for powering the electric motor, wherein the power on the supply has a characteristic feature defining an intended direction of drive of the electric motor;
a sensor for detecting the characteristic feature; an operable connector for connecting the electric power supply to the electric motor; and a control system arranged to operate the connector to connect the electric power supply to the electric motor;
wherein:
the control system is configured to:
   determine the intended direction of drive of the electric motor from an output of the sensor indicative of the characteristic feature of the electric power;
   determine if the actuator complies with a set of predetermined operating conditions for operation of the electric motor in the intended direction; and either
   inhibit operation of the electric motor if the actuator does not comply with any of the set of predetermined operating conditions; or operate the connector to connect the electric power supply to the electric motor if the actuator complies with the set of predetermined operating conditions for operation of the electric motor in the intended direction.

Signals to start the electric motor and provide the direction of drive can be provided over the electric power supply without the need for a separate control circuit with its associated cabling. Therefore, controlling the characteristic feature of the power supply can be the sole way to control the direction of operation of the motor.

The electric power supply can be a three-phase supply. The electric motor can be a three-phase motor. In this case, the characteristic feature is the sequence of phases in the three-phase supply. The connector can be configured such that changing the phase sequence of the three-phase supply reverses the direction of drive of the electric motor. Other electric power supplies and electric motors can be used, for example, single-phase supply or DC. In these cases, the characteristic feature can be a signal applied to the electric power supply, such as a modulation or other change in the electric power supply that can be detected at the actuator. The characteristic can be related to the voltage, current, or phase depending on the specific nature of the electric power supply used.

The term “connector” includes mechanical (electromechanical) or electronic connections, or electrical/electronic motor controllers, depending on the nature of the particular electric motor, electric power supply, and control system used.

The predetermined set of operating conditions can include conditions linked to the intended direction of operation. For example, the actuator can further comprise a position sensor arranged to output a signal indicative of the position of the output shaft. In this case, the control system can be configured to determine if the position of the output shaft is at or below a predetermined limit for movement in a predetermined direction and inhibit operation of the connector if the intended direction of drive of the electric motor would move the output shaft in the predetermined direction past the predetermined limit position. After the connector has been operated to connect the electric power supply to the motor to cause the electric motor to move in a predetermined direction, the control system can be configured to operate the connector to disconnect the electric power supply from the electric motor when the position sensor outputs a signal indicating that the output shaft has reached the predetermined limit for movement in the predetermined direction. This can help prevent damage to the actuator or valve from continuing to operate the electric motor when the valve has reached a fully open or fully closed position, for example, and may be against a physical stop or limit.

The actuator can further comprise a toque sensor arranged to measure torque at an output of the actuator, e.g. an output shaft. In this case, the control system can be configured to determine if the torque is at a predetermined limit for movement in a predetermined direction and inhibit operation of the connector if the intended direction of drive of the electric motor is the predetermined direction and would result in a torque exceeding the predetermined limit. After the connector has been operated to connect the electric power supply to the electric motor to cause the motor to move in a predetermined direction, the control system can be configured to operate the connector to disconnect the electric power supply from the electric motor when the torque sensor outputs a signal indicating that the torque has reached a predetermined limit for movement in the predetermined direction. This can help prevent damage to the actuator or valve from continuing to operate the electric motor when the valve has reached a fully open or fully closed position, for example, and is against a physical stop or limit or is otherwise stopped from moving further due to jamming or the like.

The predetermined set of operating conditions for the electric motor can also include conditions that are independent of the intended direction of operation. These include: the temperature of the motor must not exceed a predetermined level; the detection of a change in the electric power supply beyond a predetermined level; the detection of an error in a sensor; and the detection of a failure in the control system.

The control system can be configured to generate a position indication signal indicative of the position of a valve attached to the output shaft and generate a display of the position to the outside of the actuator using the position indication signal.

Another aspect of the invention comprises a system, comprising a series of actuators and a control station, wherein each of the actuators is connected to the control station by means of the electric power supply, and the control station includes a central control system for separately selecting the characteristic feature in the electric power supply of each actuator. The electric power supply is the only contact between the control station and the control system in each actuator.

Other aspects of the invention will be apparent from the description.

### DRAWINGS

FIG. 1 is a top view of a known actuator.

FIG. 2 is a side view of the actuator of FIG. 1.

FIG. 3 is schematic view of the control system for the actuator of FIG. 1.

FIG. 4 is a schematic view of an actuator according to an embodiment of the invention.

FIG. 5 is a schematic view of a system including multiple actuators according to an embodiment of the invention.

### DESCRIPTION

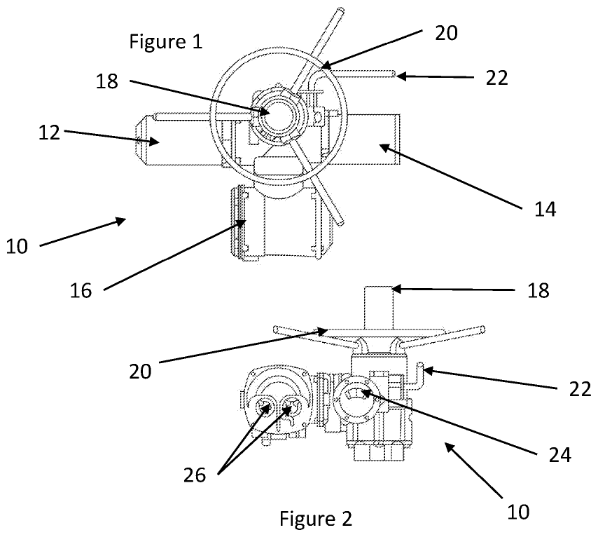

FIGS. 1 and 2 show top and side views of a known type of actuator that can be used for operation of valves (or dampers or other such devices). The actuator comprises a housing 10 enclosing a three-phase electric motor 12, a switch mechanism 14, and connections for a power supply 16. A shaft 18 extends through the housing and is driven for rotation by the motor 12. The valve (not shown) is connected to the shaft 18, either directly or though a gear box. The electric motor 12 drives the shaft by means of a worm drive. Reversing the direction of the motor reverses the direction of rotation of the shaft 18. A hand wheel 20 is provided on the shaft for manual operation of the actuator in case of motor failure, together with a lever 22 for engaging and disengaging the hand wheel 20 with the shaft 18. A position indicator 24 is provided at the end of the switch mechanism 14 and local control selectors 26 are provided on the side of the power supply connection 16.

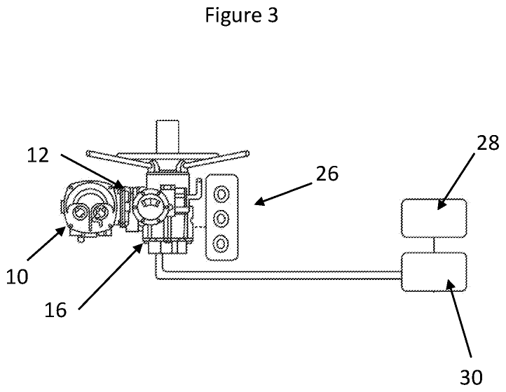

FIG. 3 shows a schematic view of the control system for the actuator of FIGS. 1 and 2. A three-phase electrical power supply 28 is connected through the power supply 16 which includes a motor control section 30 (shown outside the housing 10 but actually housed within the power supply section 16) which provides power to the motor 12. The motor control section 30 also establishes the direction of drive of the motor 12 according to the phase sequence of the three-phase supply. To operate the actuator in a given direction, an operator establishes the three-phase supply to the actuator with a given phase sequence. To change the direction of the actuator drive, the operator changes the order of two of the phases in the three-phase supply. The motor control 30 causes the motor 12 to drive in the opposite direction in response to the changed phase sequence. The cable providing the three-phase supply is the only connection to the actuator by which operating power and instructions can reach the actuator from a remote location.

In the actuators of FIGS. 1, 2, and 3, the motor 12 will begin to operate as soon as power is provided on the supply 28. Electro-mechanical switches can be used to stop the motor when the valve reaches a limit position. Protection from damage to the actuator, in particular the motor, will depend on correct installation and configuration of the switches.

An actuator according to the invention has the same basic structure as that shown in FIGS. 1 and 2 but differs in the electronics in the power supply section and the manner of operation. As with the embodiment of FIGS. 1 and 2, the three-phase cable is the only connection to the actuator by which operating power and instructions can reach the actuator from a remote location.

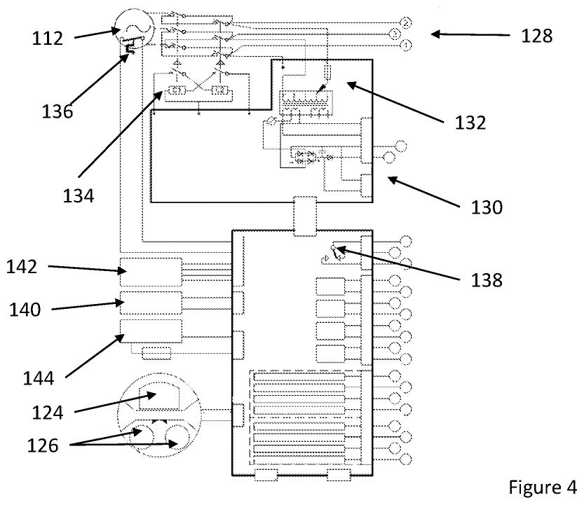

FIG. 4 shows a schematic view of the control system of an actuator according to one embodiment of the invention. As before, the actuator comprises a three-phase electric motor 112 powered from a three-phase power supply 128. The control system 130 comprises a phase detection section 132 and a connector in the form of a switching section 134. When power is provided to the actuator, the phase detection system 132 senses the sequence of the phases on the three-phase supply. The phase detection system 132 is provided with a pre-set logic that defines the intended direction of motor rotation dependent on the sequence of phases.

The switching section 134 includes two configurable switches C1, C2. In a first configuration, switch C1 is open and switch C2 is closed and the phases of the three-phase supply are connected to the motor 112 in the same sequence as in the supply. In a second configuration, switch C2 is open and switch C1 is closed and the order of two of the phases of the three-phase supply are reversed. When not operating, both switches C1 and C2 are open, i.e. there is no power to the motor 112. Only one of the switches C1, C2 can be closed at any one time. In an alternative embodiment, the switching section is electronic and can form part of an electronic motor drive.

The particular drive direction at the motor 112 for a given phase sequence, and whether this translates to opening or closing of a valve attached to the actuator will be established when the actuator is originally set up. The control system 130 detects when power is provided to the three-phase supply 128 and that there are no conditions detected that would prevent operation of the actuator in the intended direction before configuring the switching section 134.

The consequence of this arrangement is that when the switching section 134 is in the first configuration, as long as power is applied via the three-phase supply 128, the motor will operate in a given direction dependent on the phase sequence of the supply. A change in the phase sequence during operation will cause the motor 112 to reverse from its original direction.

The control system 130 includes a number of sensor inputs that will prevent operation or cease operation if certain conditions exist. The system 130 includes a monitor relay 138 which provides a motor inhibit signal that prevents the switching section 134 from providing power to the motor. This allows operation of the motor 112 to be inhibited to avoid damage to the actuator, in particular to the motor.

Some of the conditions inhibiting operation of the motor can apply independently of the intended direction of operation of the motor 112. The motor 112 includes a thermostat 136. If the temperature in the motor windings is above a predetermined level, the thermostat will trip and cause the monitor relay 138 inhibit power to the motor. Other inhibit signals causing the monitor relay 138 to inhibit the motor include signals from the phase detection system indicating the loss of a phase on the three-phase supply; the detection of an error in a position sensor (e.g. an encoder) 140 connected to the actuator shaft; and detection of a failure in the control system 130.

There are other conditions that may inhibit operation of the motor dependent on its direction of drive. For example, if the valve is fully open or fully closed, further operation in the open or close direction could cause damage to the actuator or valve. However, operation in the reverse direction (i.e. from open to closed, or closed to open) can be permitted.

The actuator includes a position sensor 140, for example at an output shaft of the actuator. Where this indicates that the valve is at a limit position, the control system 130 can inhibit operation of the motor if the phase detector 132 indicates that the intended direction of operation of the motor 112 would drive the valve further towards the limit position. If the intended direction drives the valve away from the limit opposition, there is no inhibition. The position sensor 140 can also be used to indicate when to stop operation of the motor because the valve has reached a limit position.

The actuator also includes a torque sensor 142 for detecting the torque, for example at an output of the actuator. The torque will be affected by resistance to movement of the valve (or any other factor internal to the valve or actuator that acts against the effect of the motor to turn the valve, e.g. internal jamming). Therefore, the torque will rise when the valve reaches a limit position and is prevented from moving further in the same direction. In such a case, the control system will inhibit operation of the motor 112 in the given direction but will allow operation in the reverse direction. As well as limit positions, the torque may rise due to something blocking further movement of the valve in a given direction even though the valve is not at a limit position. The output of the torque sensor 142 can also be used to stop operation of the motor 112 in this situation.

The use of the position sensor 140 and torque sensor 142 both provide a direction-dependent inhibition that prevents the control system from operating the switching section 134 to connect the power supply 128 to the motor 112 if the incoming power supply shows an intended direction of operation towards the limit or obstruction, but has no effect if operation is way from this position.

The control system 130 also includes a number of intermediate position switches S1-S4 that can be configured to open or close relays at any predetermined mid-travel position of the actuator (i.e. other than fully open or fully closed).

The control system phase detection system 132 detects the phase sequence of the incoming power supply and from this the control system 130 determines the direction of operation of the motor. This determined direction can be used, together with an output of the position encoder 140 to generate a signal indicating the direction of operation of the valve attached to the actuator.

The actuator can also include local control selectors 126 and a position indicator 124 that is visible from the outside of the housing. The valve position and direction output from the control system can be shown on the indicator 124. A battery 144 is also provided to maintain electronics functions when the three-phase power is not provided.

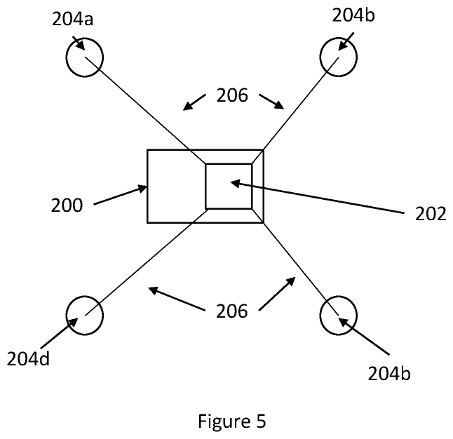

FIG. 5 shows a schematic view of a system using the actuators described above. Such a system could be an oil or gas installation having multiple valves or actuators distributed over a large area. The system comprises a control station 200 having a central control system 202 operated by an operator. The central control system 202 is connected to actuators 204a-204d by power cables 206. In use, the central control system 202 is configured to provide three-phase power to a specific valve. The phase rotation of the power supply is selected to cause the motor of the respective actuator to drive in a specific direction. Each actuator 204a-204d can be operated independently of the others. Furthermore, whether a given phase rotation results in one drive direction or the other, or whether that result in a valve opening or closing will depend on how the particular actuator is installed and configured. The power cables 206 are the only direct connection between the central control system 202 and the individual actuators 204a-204d.

Various changes can be made within the scope of the invention. While a three-phase motor and power supply are described above, the same concept can be applied for other motor topologies and power supplies, such as a DC supply, using a characteristic feature of the power supply to configure the motor drive to operate in a given direction. This feature can be a signal superposed on the current supply, for example.

1. A method for operating an actuator for a flow control valve or the like, wherein the actuator comprises:
an electric motor for driving an output shaft connected to a flow control valve;
an electric power supply for powering the electric motor, wherein the electric power has a characteristic feature defining an intended direction of drive of the electric motor;
a sensor for detecting the characteristic feature;
an operable connector for connecting the electric power supply to the electric motor; and
a control system arranged to operate the connector to connect the electric current power supply to the electric motor;
the method comprising:
providing electric power on the supply;
using the sensor to detect the characteristic feature of the electric power;
using the control system to:
determine the intended direction of drive of the electric motor from an output of the sensor indicative of the characteristic feature of the electric power; and
determine if the actuator complies with a set of predetermined operating conditions for operation of the electric motor in the intended direction; and either
inhibiting operation of the electric motor if the actuator does not comply with any of the set of predetermined operating conditions; or
operating the connector to connect the electric power supply to the electric motor if the actuator complies with the set of predetermined operating conditions for operation of the electric motor in the intended direction.

2. A method as claimed in claim 1, wherein the electric power supply is a three-phase supply.

3. A method as claimed in claim 2, wherein the electric motor is a three-phase motor.

4. A method as claimed in claim 2, wherein the characteristic feature is the sequence of phases in the three-phase supply.

5. A method as claimed in claim 4, further comprising changing the phase sequence of the three-phase supply to reverse the intended direction of drive of the electric motor.

6. A method as claimed in claim 1, wherein the electric power supply is a single-phase supply.

7. A method as claimed in claim 1, wherein the electric power supply is a DC supply.

8. A method as claimed in claim 1, wherein the actuator further comprises a position sensor arranged to output a signal indicative of the position of the output shaft.

9. A method as claimed in claim 8, further comprising:
using the control system to determine if the position of the output shaft is at a limit for movement in a predetermined direction; and
inhibiting operation of the connector if the intended direction of drive of the electric motor would move the output shaft in the predetermined direction past the limit position.

10. A method as claimed in claim 8, wherein operating the connector to connect the electric power supply to the electric motor causes the electric motor to move in a predetermined direction, the method further comprising using the control system to operate the connector to disconnect the electric power supply from the electric motor when the position sensor outputs a signal indicating that the output shaft has reached a limit for movement in the predetermined direction.

11. A method as claimed in claim 1, wherein the actuator further comprises a toque sensor arranged to measure torque at an output of the actuator.

12. A method as claimed in claim 11, further comprising:
using the control system to determine if the torque is at a predetermined limit for movement in a predetermined direction; and
inhibiting operation of the connector if the intended direction of drive of the electric motor is the predetermined direction and would result in a torque exceeding the predetermined limit.

13. A method as claimed in claim 11, wherein operating the connector to connect the electric power supply to the electric motor causes the motor to move in a predetermined direction, the method further comprising using the control system to operate the connector to disconnect the electric power supply from the electric motor when the torque sensor outputs a signal indicating that the torque has reached a limit for movement in the predetermined direction.

14. A method as claimed in claim 1, comprising generating a signal to inhibit operation of the electric motor when the control system detects at least one of the following conditions:
the temperature of the electric motor exceeds a predetermined level;
detection of a change in the electric power supply beyond a predetermined level;
detection of an error in a sensor; and
detection of a failure in the control system.

15. A method as claimed in claim 1, further comprising:
generating a position indication signal in the control system indicative of the position of a valve attached to the output shaft; and
using the position indication signal to generate a display of the position to the outside of the actuator.

16. An actuator for a flow control valve or the like, comprising:
an electric motor for driving an output shaft connected to a flow control valve;
an electric power supply for powering the electric motor, wherein the electric power has a characteristic feature defining an intended direction of drive of the electric motor;
a sensor for detecting the characteristic feature;
an operable connector for connecting the electric power supply to the electric motor; and
a control system arranged to operate the connector to connect the electric power supply to the electric motor;
wherein:
the control system is configured to:
determine if the actuator complies with a set of predetermined operating conditions for operation of the electric motor in the intended direction; and either
inhibit operation of the electric motor if the actuator does not comply with any of the set of predetermined operating conditions; or
operate the connector to connect the electric power supply to the electric motor if the actuator complies with the set of predetermined operating conditions for operation of the electric motor in the intended direction.

17. An actuator as claimed in claim 16, wherein the electric power supply is a three-phase supply.

18. An actuator as claimed in claim 17, wherein the electric motor is a three-phase electric motor.

19. An actuator as claimed in claim 17, wherein the characteristic feature is the sequence of phases in the three-phase supply.

20. An actuator as claimed in claim 19, wherein the connector is configured such that changing the phase sequence of the three-phase supply reverses the direction of drive of the electric motor.

21. An actuator as claimed in claim 16, wherein the electric power supply is a single-phase supply.

22. An actuator as claimed in claim 16, wherein the electric power supply is a DC supply.

23. An actuator as claimed in claim 16, further comprising a position sensor arranged to output a signal indicative of the position of the output shaft.

24. An actuator as claimed in claim 23, wherein the control system is configured to:
determine if the position of the output shaft is at a predetermined limit for movement in a predetermined direction; and
inhibit operation of the connector if the intended direction of drive of the electric motor would move the output shaft in the predetermined direction past the predetermined limit position.

25. An actuator as claimed in claim 23, wherein after the connector has been operated to connect the electric power supply to the electric motor to cause the motor to move in a predetermined direction, the control system is configured to operate the connector to disconnect the electric power supply from the electric motor when the position sensor outputs a signal indicating that the output shaft has reached a predetermined limit for movement in the predetermined direction.

26. An actuator as claimed in claim 16, further comprising a torque sensor arranged to measure torque at an output of the actuator.

27. An actuator as claimed in claim 26, wherein the control system is configured to:
determine if the torque is at a predetermined limit for movement in a predetermined direction; and
inhibit operation of the connector if the intended direction of drive of the electric motor is the predetermined direction and would result in a torque exceeding the predetermined limit.

28. An actuator as claimed in claim 26, wherein after the connector has been operated to connect the electric power supply to the electric motor to cause the electric motor to move in a predetermined direction, the control system is configured to operate the connector to disconnect the electric power supply from the electric motor when the torque sensor outputs a signal indicating that the torque has reached a predetermined limit for movement in the predetermined direction.

29. An actuator as claimed in claim 16, wherein the control system is configured to inhibit operation of the electric motor under at least one of the following conditions:
the temperature of the electric motor exceeds a predetermined level;
detection of a change the electric power supply beyond a predetermined level;
detection of an error in a sensor; and
detection of a failure in the control system.

30. An actuator as claimed in claim 16, wherein the control system is configured to:
generate a position indication signal indicative of the position of a valve attached to the output shaft, and
generate a display of the position to the outside of the actuator using the position indication signal.

31. A system, comprising a series of actuators as claimed in claim 16 and a control station, wherein each of the actuators is connected to the control station by means of the electric power supply, and the control station includes a central control system for separately selecting the characteristic feature in the supply of each actuator.

32. A system as claimed in claim 31, wherein the electric power supply is the only contact between the control station and the control system in each actuator.
